(19) United States
(12) Patent Application Publication
(10) Pub. No.: US 2020/0302413 A1
(43) Pub. Date: Sep. 24, 2020

(54) Accessing protected web resources using cloud paywall system

(71) Applicant: Ilya V. Moiseenko, San Jose, CA (US)

(72) Inventor: Ilya V. Moiseenko, San Jose, CA (US)

(21) Appl. No.: 16/356,941

(22) Filed: Mar. 18, 2019

(51) Int. Cl. G06Q 20/12; H04L 29/06; G06F 16/955

(52) U.S. Cl. CPC G06Q 20/123; G06F 16/9558; H04L 63/0823

(57) ABSTRACT

The present technology provides publishers of digital content and services with a convenient way of restricting access and monetizing web resources, and allows users to access these web resources with minimal effort. A system registers a protected web resource identified by a uniform resource locator (URL) and hosted on a publisher server. The system determines a fee charged for accessing the protected web resource, based on registration data provided by the publisher of digital content and services. The system displays access fee to the user. The system receives a request to access the protected web resource from the client, such as, for example, a web browser. In some embodiments, the system interacts with the publisher server to generate authorization data and provides the authorization data to the client. In some embodiments, the system interacts with the publisher server to generate authorization data, and accesses requested web resource directly, and provides the requested web resource to the client.

### TECHNICAL FIELD

The invention generally relates to the field of monetization of digital content and services, and more specifically to restricting and allowing a user to access protected web resources.

### BACKGROUND INFORMATION

As online advertising revenue decreases, providers of digital content and services are looking to augment or move their revenue stream to a paywall-based model. Paywalls can vary in design. Some experts refer to “hard” or “soft” paywalls that are more or less restrictive to users. Some hard paywalls are set up so that users cannot gain any access to a site without payment. Soft paywalls, on the other hand, may allow for limited viewing free of charge. Some paywalls offer only daily, weekly, monthly, or yearly subscriptions to entire web sites (e.g. domains). Such subscriptions usually allow users to access unlimited amount of web resources over the lifetime of the subscription. Other paywalls offer metered access to individual pieces of content, such as pay per view, pay per multiple views, etc.

Development of a coherent paywall solution represents a significant challenge, and requires a large capital investment and deep technical expertise. For a majority of providers of digital content and services these factors represent a high barrier to entry.

Furthermore, user experience might be significantly degraded, if most web publishers successfully implement individual paywall solutions. It is highly possible that a user will have to register, share sensitive financial data, and manage subscription or metered access with each individual publisher of digital content and services.

Accordingly, there is a need for systems, methods, and computer readable media that provide publishers of digital content and services with a convenient way of restricting access and monetizing web resources, and allow users to access these web resources with minimal effort.

### BRIEF DESCRIPTION OF THE DRAWINGS

FIG. 1 illustrates a network in which systems and methods consistent with principles of the invention may be implemented;

FIG. 2A illustrates a conventional bus computer system architecture according to some embodiments of the present technology;

FIG. 2B illustrates a computer system having a chipset architecture according to some embodiments of the present technology;

FIG. 3 illustrates a method of registration of protected web resource in the cloud paywall system;

FIG. 4 illustrates exemplary instances of protected web resource registration records in the cloud paywall system;

FIG. 5 illustrates a general purpose computing environment in which multiple computing devices can be configured to communicate with each other to register protected web resources, request and provide access to protected web resources;

FIG. 6 illustrates a method of facilitating access to a protected web resource from within a web document;

FIG. 7 illustrates a method of automatic retrieval of pricing information for protected web resource that is hyperlinked from within a web document;

FIG. 8 illustrates a method of requesting access to the protected web resource according to one embodiment of the present technology; and

FIG. 9 illustrates a method of requesting access to the protected web resource according to another embodiment of the present technology.

### DETAILED DESCRIPTION OF EMBODIMENTS

The following detailed description of the invention refers to the accompanying drawings. The same reference numbers in different drawings may identify the same or similar elements. Also, the following detailed description does not limit the invention.

A “web resource,” as the term is used herein, is to be broadly interpreted any machine-readable and machine-storable digital content or service. A web resource is typically uniquely addressed by a Uniform Resource Locator (URL). A web resource may include, for example, a file, a web page, image, video, audio, or a document. In the context of the Internet, a common document is a web page. Documents often include textual information and may include embedded information (such as meta information, images, hyperlinks, etc.) and/or embedded instructions (such as JavaScript, etc.). A “hyperlink,” as the term is used herein, is to be broadly interpreted to include any reference to/from a document from/to another document or another part of same document. A web resource may also represent a digital service, for example, computation, data transformation, data storage or retrieval, or a request to another digital service. A “protected web resource,” as the term used herein, is to be broadly interpreted as a web resource that can be accessed only after successful authorization.

Consistent with the principles of the invention, publishers of digital content and services may register protected web resources in a cloud paywall system (i.e. third-party paywall). After registration, cloud paywall system itself can access protected web resource hosted on publisher servers. Publishers of digital content and services may receive a code snippet, which they may include in other documents that embed (e.g. hyperlink) the protected web resource registered in the cloud paywall system. The code snippet allows users to retrieve information about the fee charged for accessing a particular protected web resource and access the web resource with minimal effort. In some embodiments, the protected web resource can be accessed directly without the code snippet by using a customized client code interacting with the cloud paywall system.

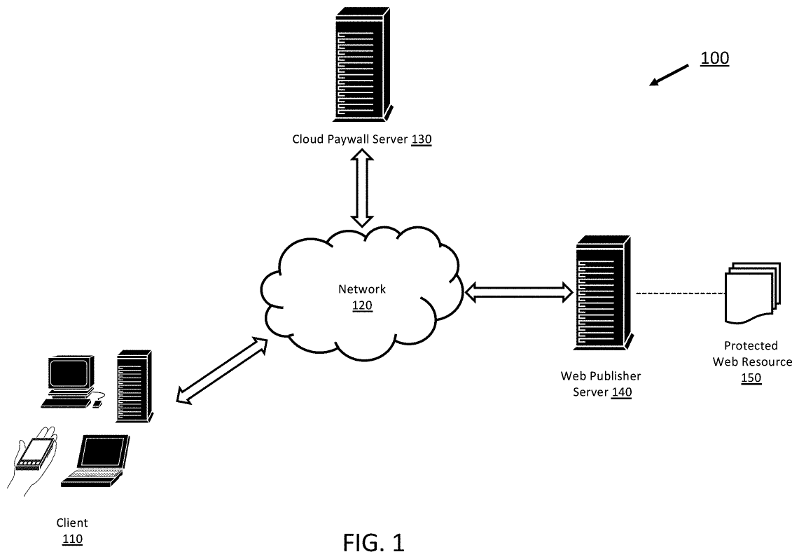

FIG. 1 is a block diagram of an example system 100 configured to perform access authorization to protected web resources. In the illustrated embodiment, system 100 includes client 110, web publisher server 140, and cloud paywall server 130. Web publisher server 140 includes protected resource 150. In this embodiment, client 110 desires to gain access to protected resource 150. Protected resource 150, however, is protected from being accessed by unauthorized clients. Client 110, web publisher server 140, and cloud paywall server 130 are configured to communicate across network 120. Network 120 is a data communication path. In one embodiment, network 120 is the Internet. In other embodiments, network 120 is a local area network, Intranet, wireless network, or any other communication path configured to communicate data from one computing system to another computing system.

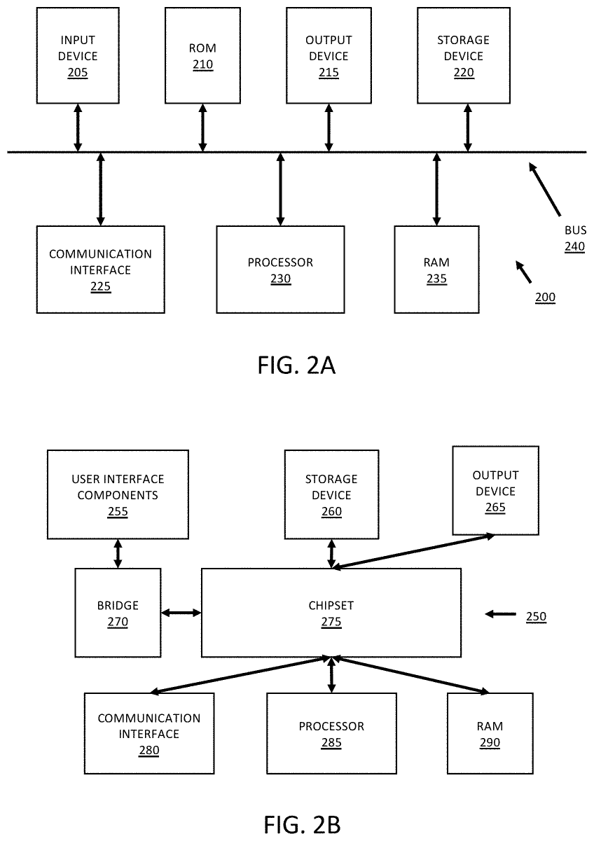

In one embodiment, client 110 is a computing system. In other embodiments, client 110 is any computing system configured to communicate data across network 120. One example of client 110 is computing system 200, shown in FIG. 2A. Another example of client 110 is computing system 250, shown in FIG. 2B. Client 110 is communicatively connected with web publisher server 140, and cloud paywall server 130 through network 120. In some embodiments, client 110 can access protected resource 150 by sending messages to cloud paywall server 130. In another embodiment, client 110 sends messages directly to web publisher server 140.

In one embodiment, web publisher server 140 is a computing system (e.g., computing system 200, shown in FIG. 2A, or computing system 250, shown in FIG. 2B). Such as a web server, operating a web service. In general, web publisher server 140 provides a useful functionality that can be accessed through network 120, using a data communication protocol. Web publisher server 140 can be used to provide an endless variety of useful functions. In one embodiment, web publisher server 140 is a server. In another embodiment, web publisher server 140 is a computing system application operating on a computing system communicatively connected to network 120. In some embodiments web publisher server 140 is a referenceable entity, processor, or resource to which web service messages can be addressed.

Generally, some embodiments of web publisher server 140 monitor network 120 for messages sent from client 110 relating to protected resource 150. When a message is received, web publisher server 140 determines whether the message contains a request that requires the authorization of client 110. Authorization of client 110 is necessary prior to permitting client 110 to access protected resource 150, and to control access to protected resource 150. In some embodiments, web publisher server 140 rejects any request from client 110 that does not carry valid authorization data. In other embodiments, web publisher server 140 might direct client 110 to cloud paywall server 130, if web publisher server 140 determines that authorization is necessary.

In the illustrated embodiment, web publisher server 140 includes protected resource 150. Protected resources include, for example, functions performed by a web publisher server 140 and data stored by web publisher server 140 that can only be accessed, used, or modified by an authorized client. For example, if web publisher server 140 provides the service of distributing real-time financial market data, the service's endpoint (i.e. URL) is a protected resource that can only be accessed, used, or modified by an authorized client. As another example, protected resource 150 is an entry in a directory. In another embodiment, protected resource 150 is a record in a database. In another embodiment, protected resource 150 is a file or part of a file stored on a memory storage device. Other embodiments use other forms of protected resources 150.

In one embodiment, cloud paywall server 130 is a computing system (e.g., computing system 200, shown in FIG. 2A, or computing system 250, shown in FIG. 2B). Such as a server communicatively connected to network 120. In another embodiment, cloud paywall server 130 is a computing system running a software application located on a network. Cloud paywall server 130 is configured to authenticate client 110. Although the illustrated embodiment shows an example of cloud paywall server 130 being separate and distinct from web publisher server 140, in other embodiments, cloud paywall server 130 and web publisher server 140 are operated on the same server.

If client 110 is authorized to perform the request contained in its message to protected resource 150, web publisher server 140 communicates the results of the requested operation to client 110. However, in other possible embodiments, cloud paywall server 130 communicates directly with web publisher server 140, across network 120, such as to receive a request for authorization from web publisher server 140, or to send a proof of authorization to web publisher server 140.

FIG. 2A illustrates a conventional system bus computer architecture 200 wherein the components of the system are in electrical communication with each other using a bus 240. Exemplary system 200 includes a processing unit (CPU or processor) 230 and a system bus 240 that couples various system components including main memory 235, read-only memory 210, storage device 220, output device 215, input device 205, and communication interface 225.

Processing unit 230 may represent any number of physically and/or logically distinct resources capable of executing software, firmware, and hardware configured to perform identified computations. Main memory 235 may include a random access memory (RAM) or another type of dynamic storage device that may store information and instructions for execution by processing unit 230. ROM 210 may include a ROM device or another type of static storage device that may store static information and instructions for execution by processing unit 230. Storage device 220 may include magnetic media and solid state media. Input device 205 may include a mechanism that permits an operator to input information to the client/server entity, such as a keyboard, a mouse, a touch detection and processing circuitry, a microphone, and so on. Output device 215 may include a mechanism that outputs information to the operator, including a display, a printer, a speaker, etc. Communication interface 225 may include mechanisms for communicating with another device or system via a network, such as network 120.

The client/server entity, consistent with the principles of the invention, may perform certain operations or processes, as will be described in detail below. The client/server entity may perform these operations in response to processing unit 230 executing software instructions contained in a computer-readable medium, such as memory 235. A computer-readable medium may be defined as a physical or logical memory device and/or carrier wave.

The software instructions may be read into memory 235 from another computer-readable medium, such as data storage device 220, or from another device via communication interface 225. The software instructions contained in the memory 235 may cause processing unit 230 to perform operations or processes that will be described in this disclosure. Alternatively, hard-wired circuitry may be used in place of or in combination with the principles of the invention. Thus, implementations consistent with the invention are not limited to any specific combination of hardware circuitry and software.

FIG. 2B illustrates a computer system 250 having a chipset architecture that can be used in executing the described method and generating and displaying a graphical user interface (GUI). Computer system 250 is an example of computer hardware, software, and firmware that can be used to implement the disclosed technology. System 250 can include a processor 285, representative of any number of physically and/or logically distinct resources capable of executing software, firmware, and hardware configured to perform identified computations. Processor 285 can communicate with chipset 275 that can control input and output from processor 285. In this example, chipset 275 outputs information to output device 265, such as a display, and can read and write information to storage device 260, which can include magnetic media, and solid state media, for example. Chipset 275 can also read from and write data to RAM 290. A bridge 270 for interfacing with a variety of user interface components 255 can be provided for interfacing with chipset 275. Such user interface components 255 can include a keyboard, a microphone, touch detection and processing circuitry, a pointing device, such as a mouse, and so on. In general, inputs to system 250 can come from any of a variety of sources, machine generated and/or human generated.

Chipset 275 can also interface with one or more communication interfaces 280 that can have different physical interfaces. Such communication interfaces can include interfaces for wired and wireless local area networks, for broadband wireless networks, as well as personal area networks. Some applications of the methods for generating, displaying and using the GUI disclosed herein can include receiving ordered datasets over the physical interface or be generated by the machine itself by processor 285 analyzing data stored in storage 260 or 290. Further, the machine can receive inputs from a user via user interface components 255 and execute appropriate functions, such as browsing functions by interpreting these inputs using processor 285.

It can be appreciated that exemplary systems 200 and 250 can have more than one processor 230 or 285, respectively, or be part of a group or cluster of computing devices networked together to provide greater processing capability.

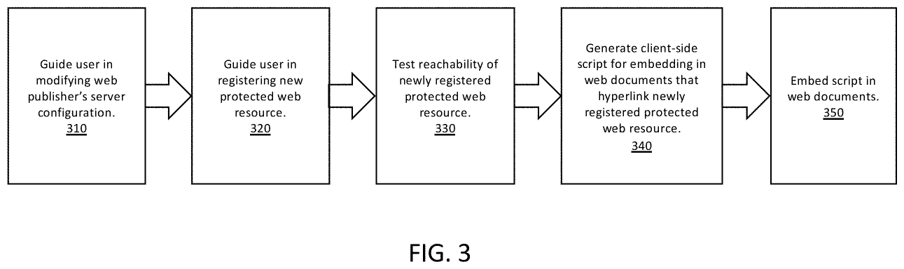

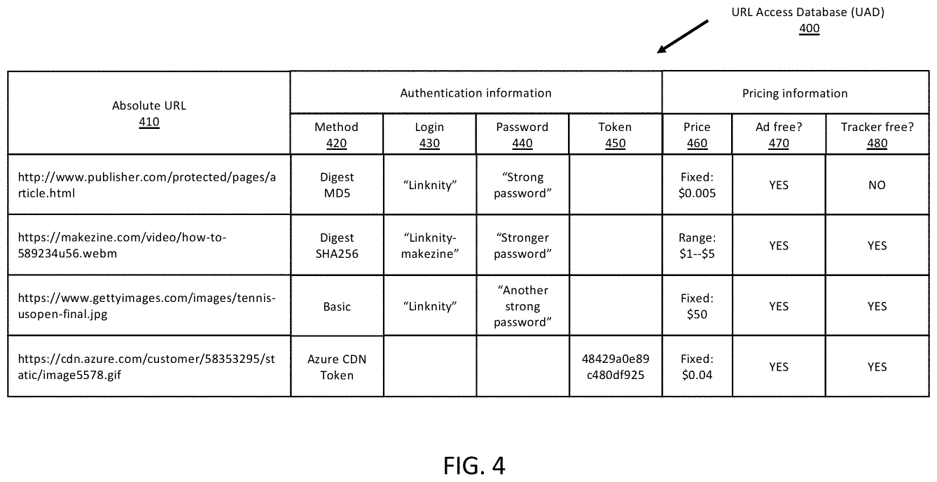

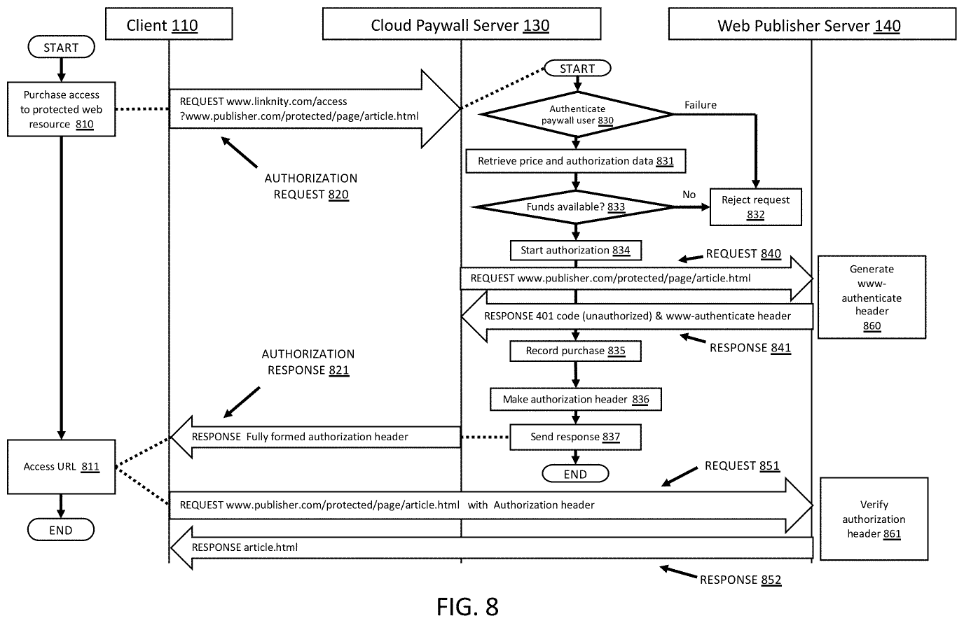

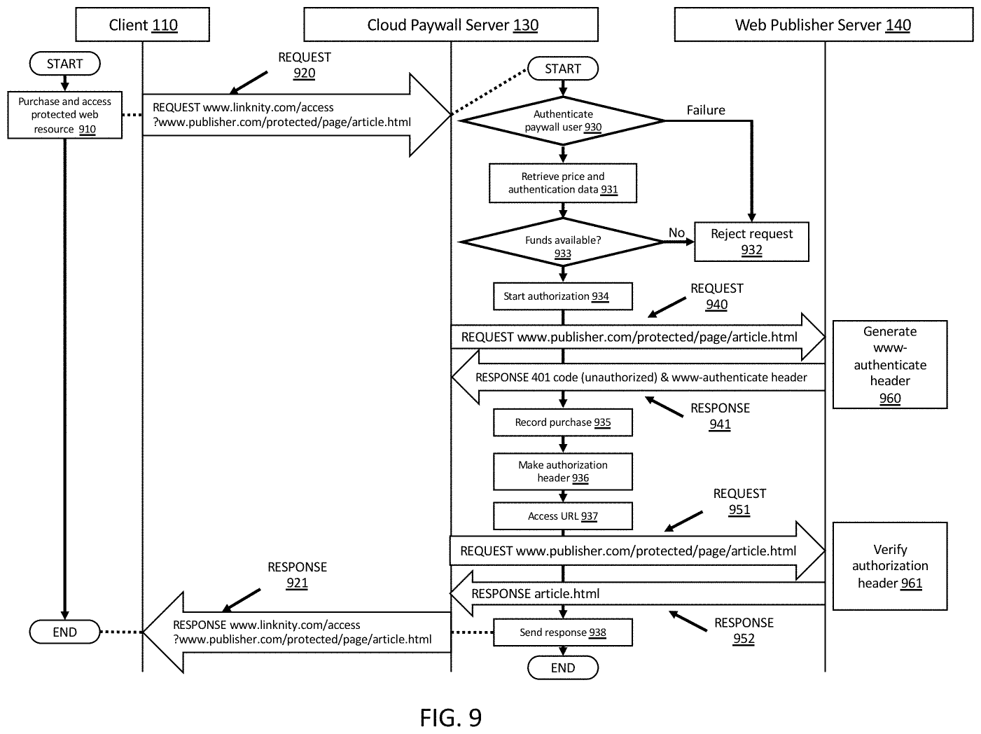

FIG. 3 illustrates a method of registration of protected web resource in the cloud paywall system. Operation 310 guides user in modifying web publisher server configuration. In one embodiment, user can select a type of web server environment used to host protected web resources and/or server authentication details, such as login and password. Login and password can also be generated automatically by the cloud paywall system. Upon completion of operation 310, user is presented with web server authentication configuration along with necessary accompanying configuration files. An example of web server authentication configuration is presented in Table 1. Operation 320 guides user in registering new protected web resource. Upon completion of operation 320, a new entry (row) is created in URL Access Database (UAD) 400 as shown in FIG. 4. Operation 330 requires user to deploy web server authentication configuration on web publisher server 140 and tests reachability of newly registered protected web resource. It uses the components of URL Access module 540 and methods illustrated by FIG. 8 and FIG. 9 to check whether newly registered protected web resource can be accessed by the cloud paywall system presented herein. Operation 340 generates a client-side script for deployment on web documents that hyperlink the newly registered protected web resource. The script is embedded in appropriate web documents (operation 350) by the web publisher using manual, semi-automatic or automatic process.

TABLE 1
Web server authentication configuration

```
<Location /protected/pages>
  AuthType Digest
  AuthName “Access requested resource through cloud paywall”
  AuthDigestDomain /protected/pages
  AuthDigestProvider file
  AuthUserFile /usr/local/apache2/conf/passwd.digest
  AuthDigestAlgorithm MD5
  Require valid-user
  AuthDigestNonceLifetime 0
</Location>
```

Operations 310, 320, 330, 340, 350 can either be performed directly by the user or through automated means, such as with pre-filed data fields, user histories and default preference settings. Pre-filed data fields include, for instance, data stored using cookie-based favorites. In addition, operations 310, 320, 330, 340, 350 can be performed through web-based application programming interface (API).

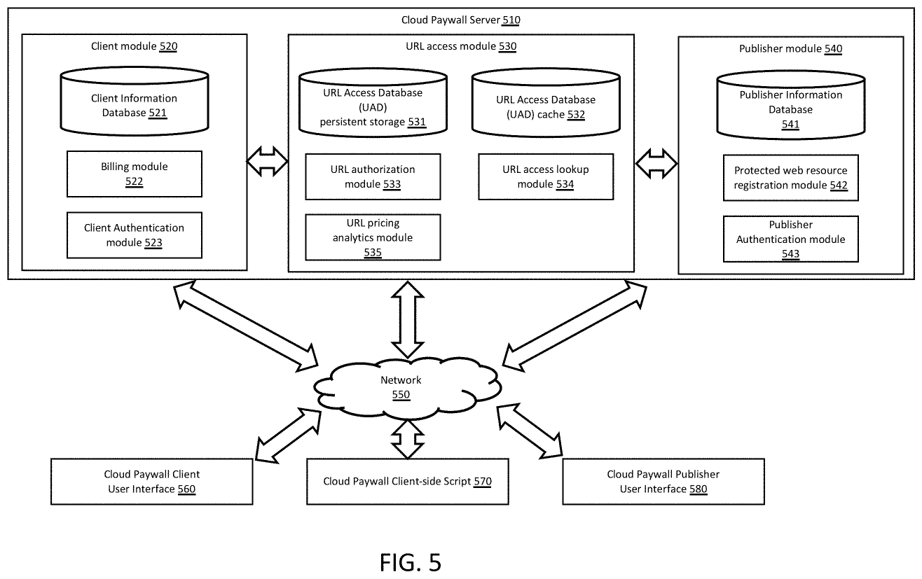

FIG. 4 is a database 400 of exemplary data used to retrieve pricing and authorization information for a requested URL of protected web resource. The database 400 can be included in the URL Access Database (UAD) persistent storage 531 or URL Access Database (UAD) cache 532 of URL access module 530 shown in FIG. 5. As shown in FIG. 4, the database 400 can include information related to each URL of protected web resource 410 that was registered in the cloud paywall system with operations shown in FIG. 3. Such information might include the method of authorization 420 required for accessing protected resource, and method-specific authorization data, such as login 430, password 440, and/or cryptographic token 450. Pricing information might include fixed or dynamic range price 460, and flag 470 indicating whether protected web resource contains web advertisements, and flag 480 indicating whether the protected web resource contains scripts tracking user activity in World Wide Web. Flags 470 and 480 are either set by the publisher as a result of operations shown in FIG. 3 or set automatically by the cloud paywall system based on scanning and analysis of newly registered protected web resource.

FIG. 5 illustrates a general purpose computing environment in which multiple computing devices can be configured to communicate with each other to register protected web resources, request and provide access to protected web resources. Although one cloud paywall server 510 is depicted, it should be understood that cloud paywall system can be configured to use multiple cloud paywall servers 510 and that client module 520, URL access module 530, and publisher module 540 can be disaggregated to run on separate cloud paywall servers 510. Furthermore, in some embodiments modules that constitute client module 520, or URL access module 530, or publisher module 540 can run on separate cloud paywall server 510.

According to some embodiments, the current technology can be configured to allow web publishers to register new protected web resources and manage the account along with existing registrations using cloud paywall publisher user interface 580 and publisher module 540 through network 550. Publisher module 540 comprises publisher information database 541, protected web resource registration module 542, and publisher authentication module 543. Publisher authentication module 543 allows web publishers to create an account in the cloud paywall system and log in to it at any time. In some embodiments, publisher information database 541 stores and provides access to information associated with a particular publisher account, such as payment information, list of verified web domain ownerships, etc. In other embodiments, publisher information database 541 stores and provides access to information associated with individual web domains, such as domain level subscription pricing information, domain level promotions and allowances for users of protected web resources. Publisher information database 541 might also store telemetry and analytics for the registered protected web resources. In some embodiments, protected web resource registration module 542 performs operations shown in FIG. 3. Protected web resource registration module 542 might also interact with one or more instances of URL Access Database (UAD) persistent storage 531 and URL Access Database (UAD) cache 532 directly or through the network.

According to some embodiments, the current technology can be configured to allow clients to access protected web resources and manage the account using cloud paywall client user interface 560 and client module 520 through network 550. Client module 520 comprises client information database 521, billing module 522, and client authentication module 523. Client authentication module 523 allows clients to create an account in the cloud paywall system, log in to it at any time and preserve long-term sessions with client module 520 and URL access module 530 using web cookies. In some embodiments, client information database 521 stores and provides access to information associated with a particular client account, such as current account balance, billing information, price limits at which protected web content is purchased automatically without additional confirmation from the user, etc. In other embodiments, client information database 521 stores and provides access to information about past purchases of protected web resources, such as time of purchase, cost of purchase, etc. In some embodiments, client information database 521 stores the list of domain level subscriptions, domain level promotions and allowances for protected web resources. Billing module 522 puts charges and adds credit to the user account.

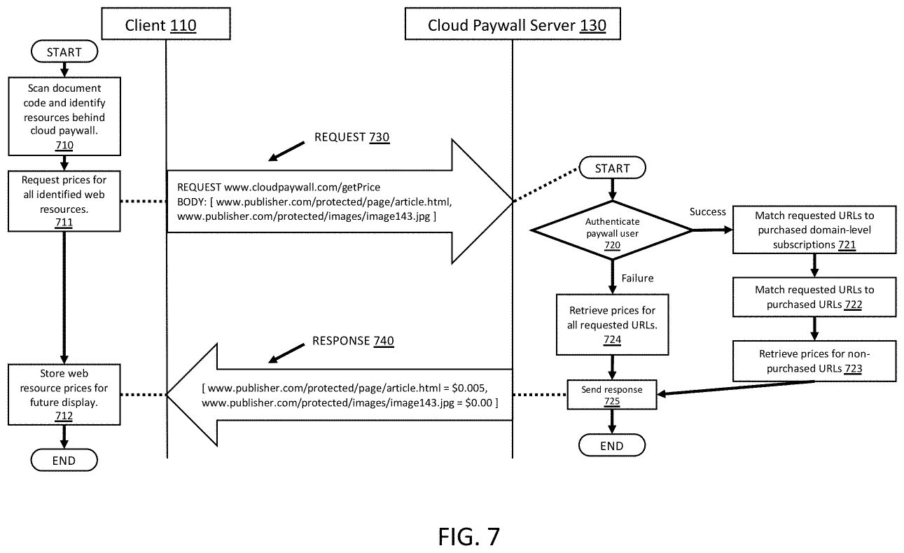

According to some embodiments, the current technology can be configured to allow clients to retrieve pricing information and access protected web resources using cloud paywall client-side script 570 and URL access module 530 through network 550. In some cases, cloud paywall client-side script 570 queries URL pricing analytics module 535, which performs actions 720-725 shown in FIG. 7. In some cases, cloud paywall client-side script 570 requests access to URL through URL authorization module 533, which performs actions 830-837 shown in FIG. 8. In some cases, cloud paywall client-side script 570 requests access to URL through URL authorization module 533, which performs actions 930-938 shown in FIG. 9.

URL authorization module 533 uses URL access lookup module 534 to query authorization information for a particular URL from URL Access Database (UAD) cache 532 and URL Access Database (UAD) persistent storage 531.

URL pricing analytics module 535 uses URL access lookup module 534 to query pricing for a particular URL from URL Access Database (UAD) cache 532 and URL Access Database (UAD) persistent storage 531. In some embodiments, in order to further determine final price of a protected web resource for a particular user, URL pricing analytics module 535 queries publisher information database 541 for domain level subscription pricing information, domain level promotions and allowances for protected web resources. In some embodiments, in order to further determine final price of a protected web resource for a particular user URL pricing analytics module 535 queries client information database 521 for domain level promotions and allowances for protected web resources and past purchases of protected web resources.

According to some embodiments, data in URL Access Database (UAD) cache 532 might be completely synchronized with data in URL Access Database (UAD) persistent storage 531. According to other embodiments, URL Access Database (UAD) cache 532 might contain only a subset of data present in URL Access Database (UAD) persistent storage 531.

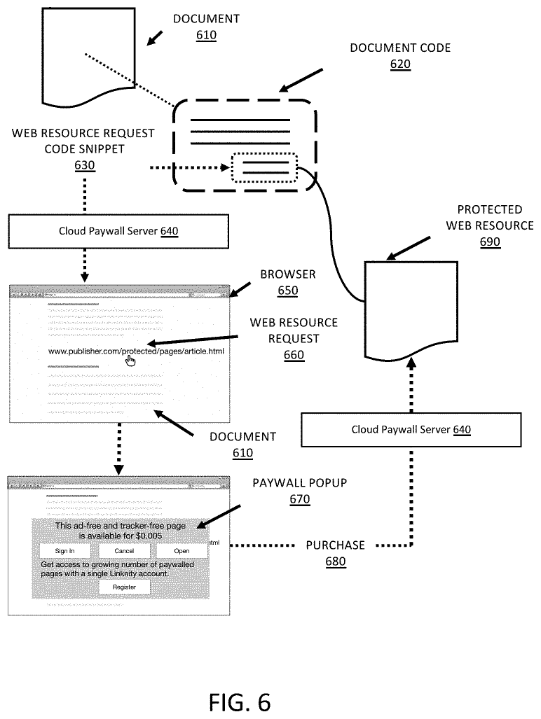

FIG. 6 illustrates an exemplary overview of the use of code embedded in a document, such as, for example, hypertext markup language (HTML) or JavaScript code generated by operation 340 shown FIG. 3, for facilitating access to a protected web resource from within the document. As shown in FIG. 6, a document 610 has document code 620 embedded in it. Document code 620 may include a web resource request code snippet 630. Web resource request code snippet 630 may include a portion of code, such as a set of code instructions, that directs web browser 650 to send a message to cloud paywall server 640 that retrieves pricing information for protected web resource 690. Browser 650, upon user initiation of document request 660, may display paywall popup 670 presenting a price of the requested document and an option to cancel or confirm the purchase. Upon purchase confirmation 680, web resource request code snippet 630 directs web browser 650 to send a message to cloud paywall server 640 to initiate the process of access authorization for protected web resource 690.

FIG. 7 illustrates a method of retrieval of pricing information for protected web resource 690 that are hyperlinked from within web document 610. The flowchart begins with the loading of the web document 610 containing the hyperlinks to protected web resources 690, or with the user initiating document request 660 by, for example, clicking on a hyperlink. Steps 710, 711, and 712 may be implemented by web resource request code snippet 630 that runs on client 110. Step 710 scans document code 620 and identifies protected web resources 690. At step 711, client 110 requests prices for all identified web resources by transmitting one or multiple requests 730 to cloud paywall server 130.

At step 720, cloud paywall server 130 attempts to authenticate cloud paywall user. In case of authentication failure, at step 724, URL pricing analytics module 535 retrieves prices for all requested URLs using URL access lookup module 534.

In case of authentication success, at step 721, URL pricing analytics module 535 matches requested URLs to domain-level subscriptions purchased by the user and stored in client information database 521. At step 722, URL pricing analytics module 535 matches requested URLs to URLs purchased by the user and stored in client information database 521. In some embodiments, if matching at steps 721 or 722 is successful then protected web resource can be accessed at no additional cost. At step 723, URL pricing analytics module 535 retrieves prices for all other requested URLs using URL access lookup module 534.

At step 725, URL pricing analytics module 535 transmits one or multiple responses 740 to client 110. At step 712, client 110 stores retrieved prices for future display.

FIG. 8 illustrates a method of requesting access to the protected web resource according to one embodiment of the present technology. The flowchart begins with the user initiating document request 660 by, for example, clicking on a hyperlink. Steps 810 and 811 may be implemented by a web resource request code snippet 630 that runs on client 110. At step 810, client 110 attempts to purchase access to protected web resource 150 by transmitting authorization request message 820 to cloud paywall server 130. In some embodiments, step 810 may be initiated by user purchase confirmation 680 after browser 650 displays paywall popup 670. In other embodiments, step 810 may be initiated directly by web resource request 660 without any additional display of paywall popup 670 in browser 650.

At step 830, cloud paywall server 130 attempts to authenticate cloud paywall user using client authentication module 523. In case of authentication failure, at step 832, the request is rejected and response message 821 is transmitted to client 110.

In case of authentication success, at step 831, price and authorization information for requested protected web resource 150 is retrieved. Price retrieval may include steps 721, 722, 723 shown in FIG. 7. The flowchart continues with the step 833, at which billing module 522 ensures that client account in client information database 521 has sufficient funds for purchase of protected web resource 150. In case of insufficient funds, billing module 522 may reject authorization request 820 and transmit authorization response message 821 to client 110.

In case of sufficient funds, the flowchart continues with step 834, at which URL authorization module 533 transmits a request message 840 to web publisher server 140. At step 860, web publisher server 140 generates www-authenticate header which may contain such values as nonce, opaque and realm, and transmits response message 841 to cloud paywall server 130. Flowchart continues with step 835, at which purchase is recorded and user may be charged a fee for accessing the web resource. At step 836, URL authorization module 533 generates authorization header using the information from response message 841 and authorization data retrieved at step 831. In some embodiments, step 836 may use cryptographic operations such as MD-5, SHA-256, or other type of digest computation. At step 837, cloud paywall server 130 transmits authorization response message 821 containing fully formed authorization header to client 110. Flowchart continues with step 811, at which client includes authorization header from authorization response message 821 in request message 851 and transmits request message 851 to web publisher server 140 to retrieve protected web resource 150.

At step 861, web publisher server 140 verifies authorization header. In some embodiments, authorization header is verified by computing MD-5 digest, or SHA-256 digest, or other type of digest and matching that digest to the digest from authorization header of request message 851. In other embodiments, authorization header is verified by matching login and password information from authorization header of request message 851 to login and password information stored at web publisher server 140. If verification of authorization header is successful, web publisher server 140 transmits response message 852 which contains requested web resource. If verification of authorization header is unsuccessful, web publisher server 140 transmits response message 852 which contains an error code.

FIG. 9 illustrates a method of requesting access to the protected web resource according to another embodiment of the present technology. The flowchart begins with the user initiating document request 660 by, for example, clicking on a hyperlink. Step 910 may be implemented by a web resource request code snippet 630 that runs on client 110. At step 910, client 110 attempts to purchase and access protected web resource 150 by transmitting request message 920 to cloud paywall server 130. In some embodiments, step 910 may be initiated by user purchase confirmation 680 after browser 650 displays paywall popup 670. In other embodiments, step 910 may be initiated directly by web resource request 660 without any additional display of paywall popup 670 in browser 650.

At step 930, cloud paywall server 130 attempts to authenticate cloud paywall user using client authentication module 523. In case of authentication failure, at step 932, request is rejected and response message 921 is transmitted to client 110.

In case of authentication success, at step 931, price and authorization information for requested protected web resource is retrieved. Price retrieval may include steps 721, 722, 723. The flowchart continues with the step 933, at which billing module 522 ensures that client account in client information database 521 has sufficient funds for purchase of request web resource 150. In case of insufficient funds, billing module 522 may reject request 920 and transmit response message 921 to client 110.

In case of sufficient funds, the flowchart continues with step 934, at which URL authorization module 533 transmits request message 940 to web publisher server 140. At step 960, web publisher server 140 generates www-authenticate header which may contain such values as nonce, opaque and realm, and transmits response message 941 to cloud paywall server 130. Flowchart continues with step 935, at which purchase is recorded and user may be charged a fee for accessing the web resource. At step 936, URL authorization module 533 generates authorization header using the information from response message 941 and authorization data retrieved at step 931. In some embodiments, step 936 may use cryptographic operations such as MD-5, SHA-256, or other type of digest computation. In other embodiments, step 936 may pass authorization information such as login and password in plain text without MD-5, SHA-256, or other type of digest computation.

At step 937, cloud paywall server 130 includes authorization header from previous step in request message 951 and transmits request message 951 to web publisher server 140. At step 961, web publisher server 140 verifies authorization header. In some embodiments, authorization header is verified by computing MD-5 digest, or SHA-256 digest, or other type of digest and matching that digest to the digest from authorization header of request message 951. In other embodiments, authorization header is verified by matching login and password information from authorization header of request message 951 to login and password information stored at web publisher server 140. If verification of authorization header is successful, web publisher server 140 transmits response message 952 which contains requested web resource. If verification of authorization header is unsuccessful, web publisher server 140 transmits response message 952 which contains an error code. The flowchart continues with step 938, at which cloud paywall 130 receives response message 952 and passes it to client 110 in response message 921.

Note that in this Specification, references to various features (e.g., elements, structures, nodes, modules, components, logic, steps, operations, functions, characteristics, etc.) included in “one embodiment”, “example embodiment”, “an embodiment”, “another embodiment”, “certain embodiments”, “some embodiments”, “various embodiments”, “other embodiments”, “alternative embodiments”, and the like are intended to mean that any such features are included in one or more embodiments of the present disclosure, but may or may not necessarily be combined in the same embodiments. Note that a module, engine, client, controller, function, logic, or the like as used herein this Specification, can be inclusive of an executable file comprising instructions that can be understood and processed on a computer, processor, machine, compute node, combinations thereof, or the like and may further include library modules loaded during execution, object files, system files, hardware logic, software logic, and/or any other executable modules.

It is also important to note that the operations and steps described with reference to the preceding FIGURES illustrate only some of the possible scenarios that may be executed by, or within, the communication system 100. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Note that with the examples provided above, as well as numerous other examples provided herein, interactions may be described in terms of one, two, three, or four network elements. However, this has been done for purposes of clarity and example only. In certain cases, it may be easier to describe one or more of the functionalities by only referencing a limited number of network elements. It should be appreciated that communication system 100 (and its teachings) are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

As used herein, unless expressly stated to the contrary, use of the phrase “at least one of”, “one or more of”, “and/or”, variations thereof, or the like are open ended expressions that are both conjunctive and disjunctive in operation for any combination of named elements, conditions, or activities. For example, each of the expressions “at least one of X, Y, and Z”, “at least one of X, Y, or Z”, “one or more of X, Y, and Z”, “one or more of X, Y, or Z”, and “A, B, and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred herein, “at least one of” and “one or more of” can be represented using the “(s)” nomenclature (e.g., one or more elements(s)).

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although embodiments herein have been illustrated with reference to particular elements and protocols, these elements and protocols may be replaced by any suitable architecture, protocols, and/or processes that achieve the intended functionality of accessing protected web resources using cloud paywall system as disclosed herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (1) does not intend any of the appended claims to invoke paragraph (f) of 35 U.S.C. Section 112 as it exists on the date of the filing hereof unless the words “means for” or “step for” are specifically used in the particular claims; and (2) does not intend, by any statement in the specification, to limit this disclosure in any way that is not otherwise reflected in the appended claims.

What is claimed is:

1. A method performed by one or more computing devices, the method comprising:
registering, in a cloud paywall system, a protected web resource identified by a uniform resource locator (URL) and hosted on a publisher server;
determining, a fee charged for accessing the protected web resource through the cloud paywall system;
accessing, the protected web resource, by a client using the cloud paywall system, wherein the protected web resource is hosted on the publisher server;

2. The method of claim 1, further comprising:
generating, a first snippet of code, wherein the first snippet of code includes publisher server configuration;
transmitting, a first snippet of code to the publisher;
generating, authorization data for accessing the protected web resource hosted on the publisher server, wherein authorization data is shared between the publisher server and the cloud paywall system;
verifying, using shared authorization data, reachability of the protected web resource hosted on the publisher server through the cloud paywall system;
generating, a second snippet of code, wherein the second snippet of code includes instructions directing the client to request fee information and access the protected web resource through the cloud paywall system;
transmitting, the second snippet of code to the publisher;

3. The method of claim 1, further comprising:
finding, a hyperlink to the protected web resource in a document code, when a document is rendered by the client;
sending, a request for information about the fee charged for accessing the protected web resource found in the document code;
determining, the fee to charge for accessing the protected web resource;
receiving, a response with information about the fee charged for accessing the protected web resource;
displaying, the fee information, when a user attempts to access the protected web resource;

4. The method of claim 1, further comprising:
sending, by the client, a first request message to the cloud paywall server, wherein the first request message includes a URL of the protected web resource;
sending, by the cloud paywall server, a second request message server to the publisher server, wherein the second request message carries the URL of the protected web resource;
receiving, at the cloud paywall server, a first response message from the publisher server, where the first response message carries the URL of the protected web resource and initial authorization data;
generating, at the cloud paywall server, complete authorization data using the initial authorization data carried in the first response message and shared authorization data stored in the cloud paywall system;
receiving, at the client, a second response message from the cloud paywall server, where the second response message carries complete authorization data for accessing the protected web resource;
sending, by the client, a third request message to the publisher server, where the third request message carries the URL of the protected web resource and complete authorization data;
receiving, at the client, a third response message from the publisher server, where the third response message carries the URL and the contents of the protected web resource;

5. The method of claim 1, further comprising:
sending, by the client, a first request message to the cloud paywall server, wherein the first request message includes a URL of the protected web resource;
sending, by the cloud paywall server, a second request message to the publisher server, wherein a URL of the request message carries the URL of the protected web resource;
receiving, at the cloud paywall server, a first response message from the publisher server, where the first response message carries the URL of the protected web resource and initial authorization data;
generating, at the cloud paywall server, complete authorization data using the initial authorization data carried in the first response message and shared authorization data stored in the cloud paywall system;
sending, by the cloud paywall server, a third request message to the publisher server, where the third request message carries the URL of protected web resource and complete authorization data;
receiving, at the cloud paywall server, a second response message from the publisher server, where the second response message carries the URL and the contents of the protected web resource;
receiving, at the client, a third response message from the cloud paywall server, wherein the third response message includes the URL and the contents of the protected web resource;

6. The method of claim 1, where the client comprises a web browser.

7. The method of claim 1, where the client comprises a smartphone, desktop or server application accessing web resources.

8. The method of claim 2, where the second snippet of code comprises hypertext markup language (HTML) or JavaScript code.

9. The method of claim 2, where the second snippet of code includes instructions directing the client to request fee information for the protected web resource for display in a client popup message.

10. The method of claim 3, further comprising:
receiving, at the cloud paywall server, a request for information about the fee charged for accessing the protected web resource;
determining, at the cloud paywall server, whether a URL of the protected web resource belongs to a domain from a set of domain-level subscriptions purchased by the user;
determining, at the cloud paywall server, whether a URL of the protected web resource is in a set of URLs of protected web resources purchased by a user;
determining, at the cloud paywall server, the fee to charge for accessing the protected web resource;
sending, by the cloud paywall server, a response with information about the fee charged for accessing the protected web resource;

11. A computer-readable non-transitory medium comprising single or multiple instructions, the instructions when executed on a processor are operable to:
register, in a cloud paywall system, the protected web resource identified by the uniform resource locator (URL) and hosted on the publisher server;
determine, the fee to charge for accessing the protected web resource through the cloud paywall system;
access, the protected web resource, by the client using the cloud paywall system, wherein the protected web resource is hosted on a publisher server;

12. The computer-readable non-transitory medium of claim 11, wherein the instructions when executed are further operable to:
generate, a first snippet of code, wherein the first snippet of code includes publisher server configuration;
transmit, the first snippet of code to the publisher;
generate, authorization data for accessing the protected web resource hosted on the publisher server, wherein authorization data is shared between the publisher server and the cloud paywall server;
verify, using shared authorization data, reachability of the protected web resource hosted on the publisher server through the cloud paywall system;
generate, a second snippet of code, wherein the second snippet of code includes instructions directing the client to request fee information and access the protected web resource through the cloud paywall system;
transmit, the second snippet of code to the publisher;

13. The computer-readable non-transitory medium of claim 11, wherein the instructions when executed are further operable to:
find, a hyperlink to the protected web resource in a document code, when the document is rendered by the client;
send, a request for information about the fee charged for accessing the protected web resource found in the document code;
determine, the fee to charge for accessing the protected web resource;
receive, a response with information about the fee charged for accessing the protected web resource;
display, fee information, when a user attempts to access the protected web resource;

14. The computer-readable non-transitory medium of claim 11, wherein the instructions when executed are further operable to:
send, by the client, a first request message to the cloud paywall server, wherein the first request message includes a URL of the protected web resource;
send, by the cloud paywall server, a second request message to the publisher server, wherein the second request message carries the URL of the protected web resource;
receive, at the cloud paywall server, a first response message from the publisher server, where the first response message carries the URL of the protected web resource and initial authorization data;
generate, at the cloud paywall server, complete authorization data using the initial authorization data carried in the first response message and shared authorization data stored in the cloud paywall system;
receive, at the client, a second response message from the cloud paywall server, where the second response message carries complete authorization data for accessing the protected web resource;
send, by the client, a third request message to the publisher server, where the third request message carries the URL of protected web resource and complete authorization data;
receive, a third response message from the publisher server, where the third response message carries the URL and the contents of the protected web resource;

15. The computer-readable non-transitory medium of claim 11, wherein the instructions when executed are further operable to:
send, by the client, a first request message to the cloud paywall server, wherein the first request message includes a URL of the protected web resource;
send, by the cloud paywall server, a second request message to the publisher server, wherein the second request message carries the URL of the protected web resource;
receive, at the cloud paywall server, a first response message from the publisher server, where the first response message carries the URL of the protected web resource and initial authorization data;
generate, at the cloud paywall server, complete authorization data using the initial authorization data carried in the first response message and shared authorization data stored in the cloud paywall system;
send, at the cloud paywall server, a third request message to the publisher server, where the third request message carries the URL of protected web resource and complete authorization data;
receive, at the cloud paywall server, a second response message from the publisher server, where the second response message carries the URL and the contents of the protected web resource;
receive, at the client, a third response message from the publisher server, wherein the third response message includes the URL and the contents of the protected web resource;

16. The computer-readable non-transitory medium of claim 11, where the client comprises a web browser.

17. The computer-readable non-transitory medium of claim 11, where the client comprises a smartphone, desktop or server application accessing web resources.

18. The computer-readable non-transitory medium of claim 12, where the second snippet of code comprises hypertext markup language (HTML) or JavaScript code.

19. The computer-readable non-transitory medium of claim 12, where the second snippet of code includes instructions directing the client to request fee information for the protected web resource for display in a client popup message.

20. The computer-readable non-transitory medium of claim 13, wherein the instructions when executed are further operable to:
receive, at the cloud paywall server, a request for information about the fee charged for accessing the protected web resource;
determine, at the cloud paywall server, whether a URL of the protected web resource belongs to a domain from a set of domain-level subscriptions purchased by the user;
determine, at the cloud paywall server, whether a URL of the protected web resource is in a set of URLs of protected web resources purchased by the user;
determine, at the cloud paywall server, the fee to charge for accessing the protected web resource;
send, by the cloud paywall server, a response with information about the fee charged for accessing the protected web resource;
